(19) United States
(12) Patent Application Publication
(10) Pub. No.: US 2011/0303096 A1
(43) Pub. Date: Dec. 15, 2011

(54) TEA POT HAVING A REPLACEABLE STRAINER

(75) Inventor: Yuan-Huei Lin, TAIPEI CITY (TW)

(73) Assignee: INTERCON TRADER LTD., TAIPEI CITY (TW)

(21) Appl. No.: 12/814,487

(22) Filed: Jun. 14, 2010

(51) Int. Cl. A47J 31/20

(52) U.S. Cl. 99/319

(57) ABSTRACT

A tea pot having a replaceable strainer includes a strainer, a cover and a knob. The tea pot is shaped as a cup body having a containment space. The strainer has a pull rod extending upward from a center position. An upper end of the pull rod has an assembly end and a positioning ring slot set below the assembly end. The cover is designed for covering an upper opening of the tea pot and has a through aperture at a center position. The knob comprises a main body, a housing, an elastic member and a positioning member. The main body has an extended hollow rod, and the housing is jacketed onto the main body.

### BACKGROUND OF THE INVENTION

1. Field of the Invention

The present invention relates to a tea pot, and more particularly to a tea pot having a replaceable strainer.

2. Description of the Related Art

Currently, a prior art tea pot, as shown in FIG. 9, has a cup body 50 and a mixer 60. The cup body 50 provides a containment space, and the mixer 60 has an extended pull rod 61 at a center position. The pull rod 61 passes through a cover 62 and has a stopper 63 at another end, and the cover 62 is used for covering the cup body 50. When placed on the cup body, the cover 62 allows the mixer 60 to drop naturally, and the stopper 63 on the mixer 60 is stopped by the cover 62. To make drinks, drinking materials can be placed in the containment space 51 of the cup body 50, and by moving the mixer 60 up and down, the drinking materials in the containment space 51 are mixed.

The above-mention prior art has the following drawbacks: the pull rod 61 of the mixer 60 is limited by the stopper 63 and the cover 62 and cannot be removed. Therefore, the tea pot 60 can only employee the mixer 60 for some certain drink materials and is incapable of be used for other types of drinking materials.

Therefore, it is desirable to provide a tea pot having a replaceable strainer to mitigate and/or obviate the aforementioned problems.

### SUMMARY OF THE INVENTION

An objective of the present invention is to provide a tea pot having a replaceable strainer.

In order to achieve the above mentioned objective, the tea pot has a replaceable strainer and comprises a strainer, a cover and a knob. The tea pot is shaped as a cup body having a containment space. The strainer has a pull rod extending upward from a center position. An upper end of the pull rod provides an assembly end and a positioning ring slot below the assembly end; the cover is designed for covering an upper opening of the tea pot and has a through aperture at a center position. The knob comprises a main body and a housing. The knob also has an elastic member and a positioning member. The main body has an extended hollow rod, and the housing is jacketed onto the main body.

When the pull rod of the strainer passes through the through aperture of the cover, the assembly end is exposed from the cover; the knob is secured onto the assembly end of the pull rod. The assembly end of the pull rod passes through the hollow rod, and the positioning ring slot is engaged with the positioning member of the hollow rod. When the cover is placed on the tea pot the cover forces the strainer to drop down into the containment space of the tea pot, and the strainer employs the knob to engage with the cover.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of an embodiment of the present invention.

FIG. 2 is an exploded view of an embodiment of the present invention.

FIG. 3 is shows a preferred embodiment of the present invention.

FIG. 4 is a local detailed view of a knob according to an embodiment of the present invention.

FIG. 5 is a perspective view of an embodiment of the present invention.

FIG. 6 is a schematic drawing showing movements of a knob according to an embodiment of the present invention.

FIG. 7 is a schematic drawing of disassembly of a knob according to an embodiment of the present invention.

FIG. 8 is another schematic drawing of an embodiment of the present invention.

FIG. 9 is a perspective view of a prior art tea pot.

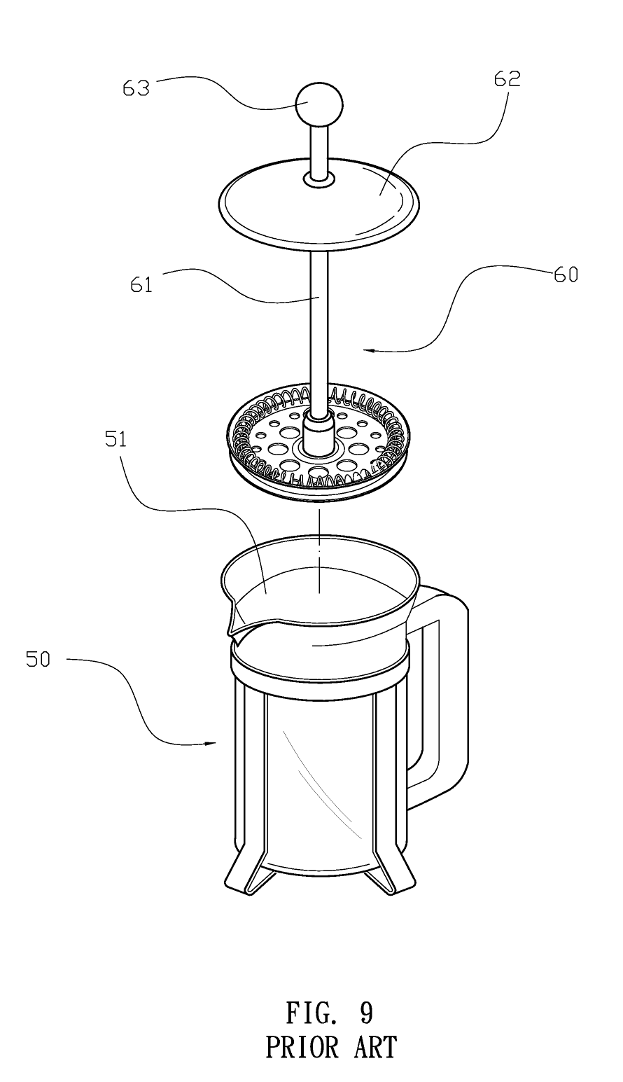

### DETAILED DESCRIPTION OF THE PREFERRED EMBODIMENT

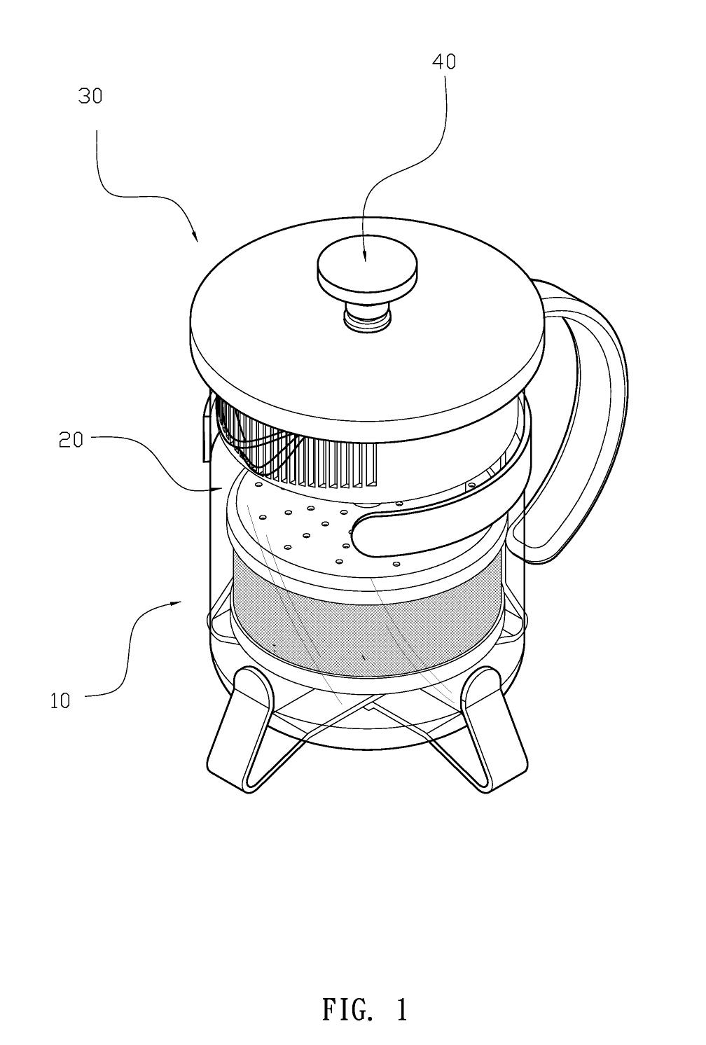

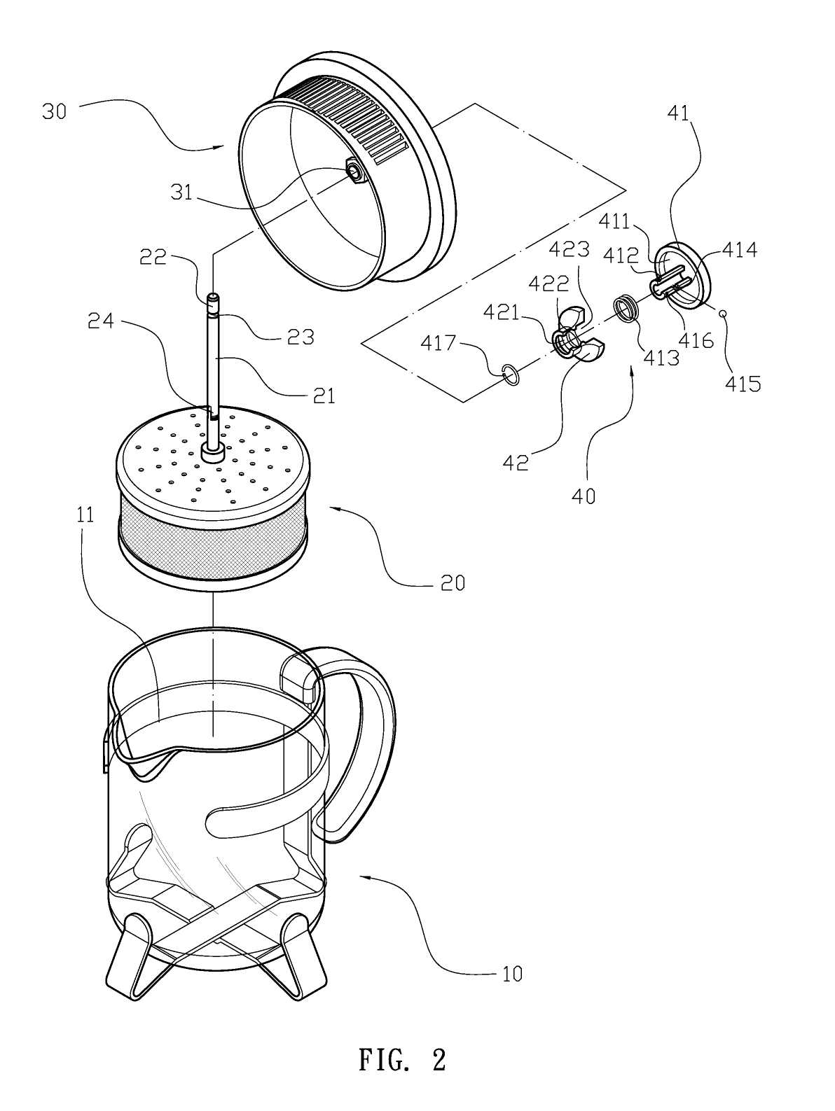

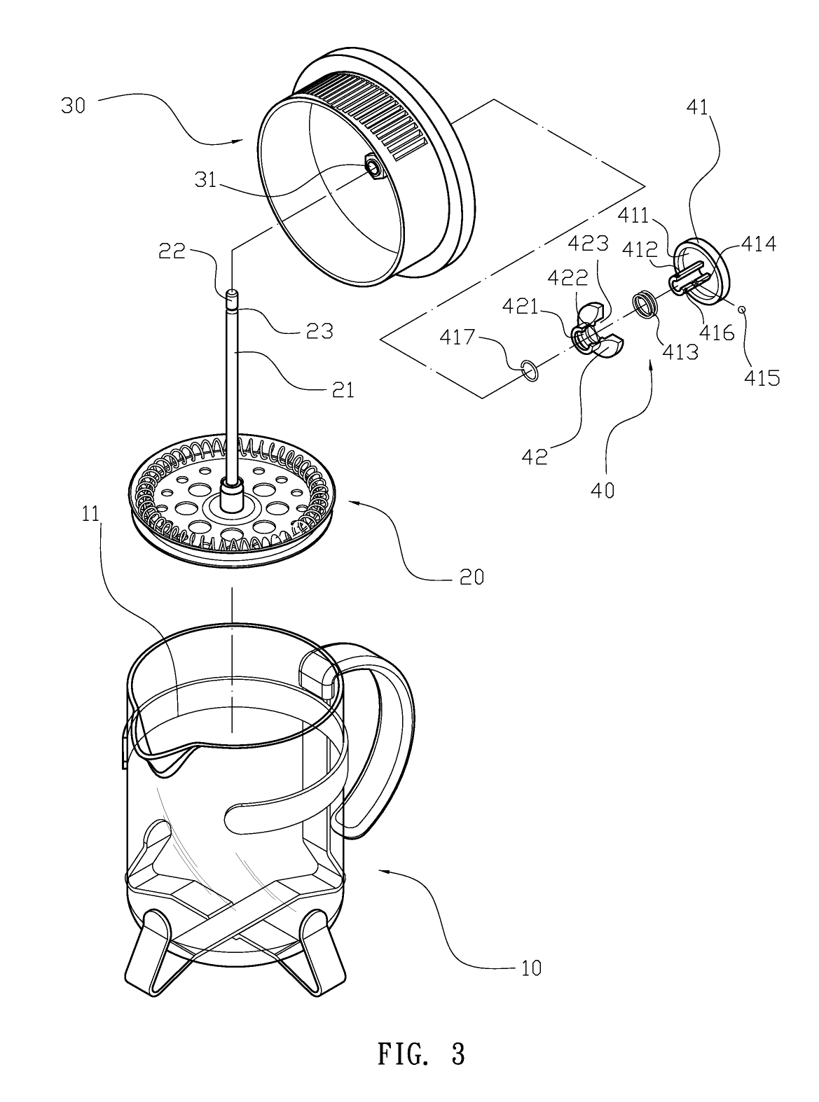

First, please refer to FIGS. 1, 2 and 4. A tea pot 10 comprises a strainer 20, a cover 30 and a knob 40. The tea pot 10 is shaped as a cup body having a containment space 11, and the strainer 20 is a soak with screened sidewalls or a mixer, as shown in FIG. 3. The strainer 20 has a pull rod 21 extending upward from a center position, and an upper end of the pull rod forms an assembly end 22 and a positioning ring slot 23 below the assembly end 22. The pull rod 21 is a rigid rod body as shown in FIG. 3 or comprises two connected rods with a joint 24 as shown in FIG. 2. The cover 30 is designed for covering an upper opening of the tea pot 10 and has a through aperture 31 at a center position. The knob 40 comprises a main body 41 and a housing 42. The main body 41 has an internal space 411 on one side and a hollow rod 412 is disposed in the center position on the same side. The hollow rod 412 is jacketed by an elastic member 413 and has a tapered aperture 414 and a positioning member 415, such as a bearing, disposed at a central position on the hollow rod 412. An engaging slot 416 is disposed around an end of the hollow rod 412, and a fastening member 417 is engaged with the slot 416. The housing 42 is engaged with the main body 41 and has a hollow tapered shape with one end corresponding to the inner space 411 of the main body 41. A containment aperture 421 is defined by an inner sidewall of the housing 42, and a securing slot 422 is formed in the inner sidewall around the containment aperture 421. An enlarged end of the housing 42 further has a limiting opening 423 having a larger diameter than a diameter of the containment aperture 421 such that when the housing 42 is jacketed onto the hollow rod 412 of the main body 41 with the containment aperture 421, the limiting opening 423 pushes against the elastic member 413 and the securing slot 422 pushes against the positioning member 415, and a fastening member 417 is secured onto the engaging slot 416 of the hollow rod 412 to secure the housing 42 onto the hollow rod 412 of the main body 41.

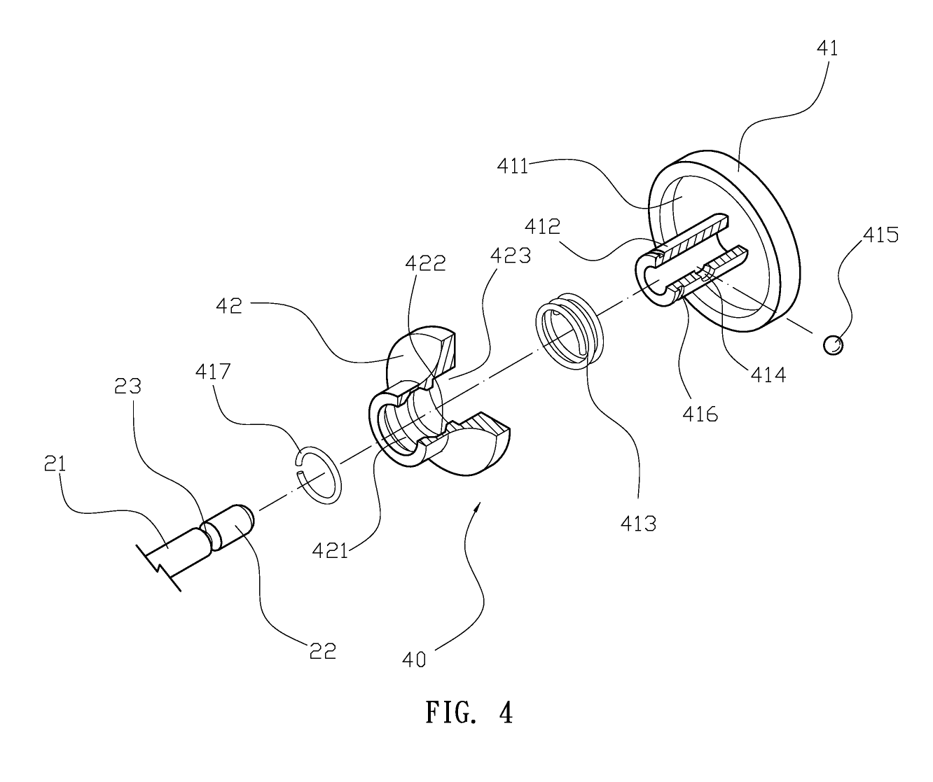

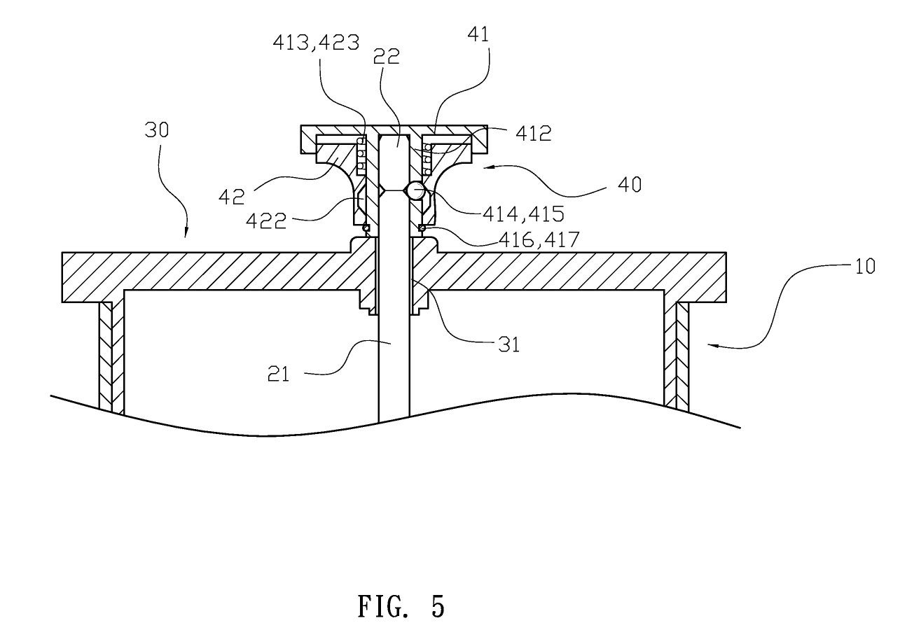

For assembly, please refer to FIG. 2 with FIGS. 4 and 5. The pull rod 21 of the strainer 20 passes through the through aperture 31 of the cover 30, and the assembly end 22 is exposed from the cover 30. The knob 40 is secured onto the assembly end 22 of the pull rod 21; the assembly end 22 of the pull rod 21 passes through the hollow rod 412, and the positioning ring slot 23 is engaged with the positioning member 415 of the hollow rod 412. When the cover 30 is placed on the tea pot 10 the cover 30 forces the strainer 20 to drop down into the containment space 11 of the tea pot 10, and the strainer 20 employs the knob 40 to engage with the cover 30.

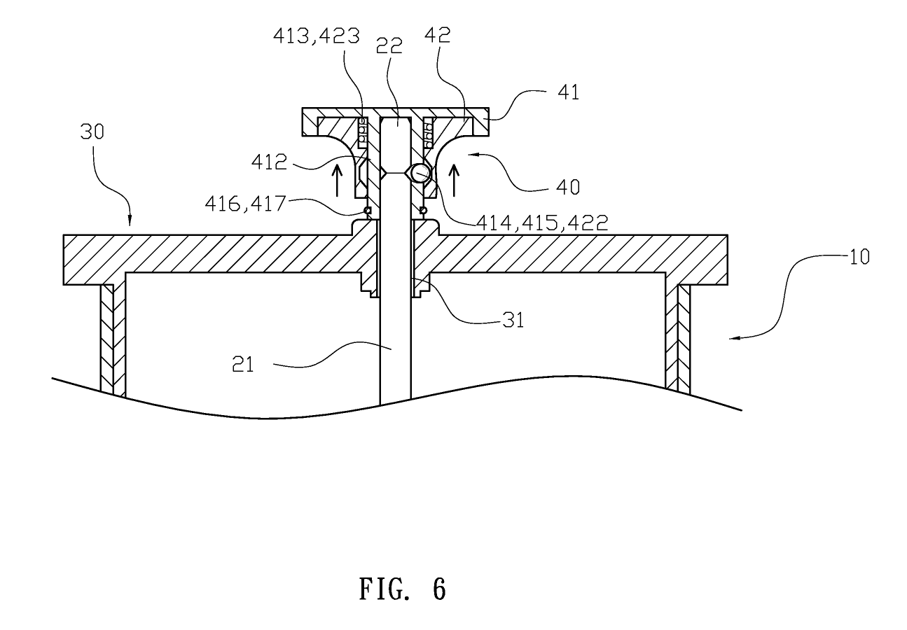

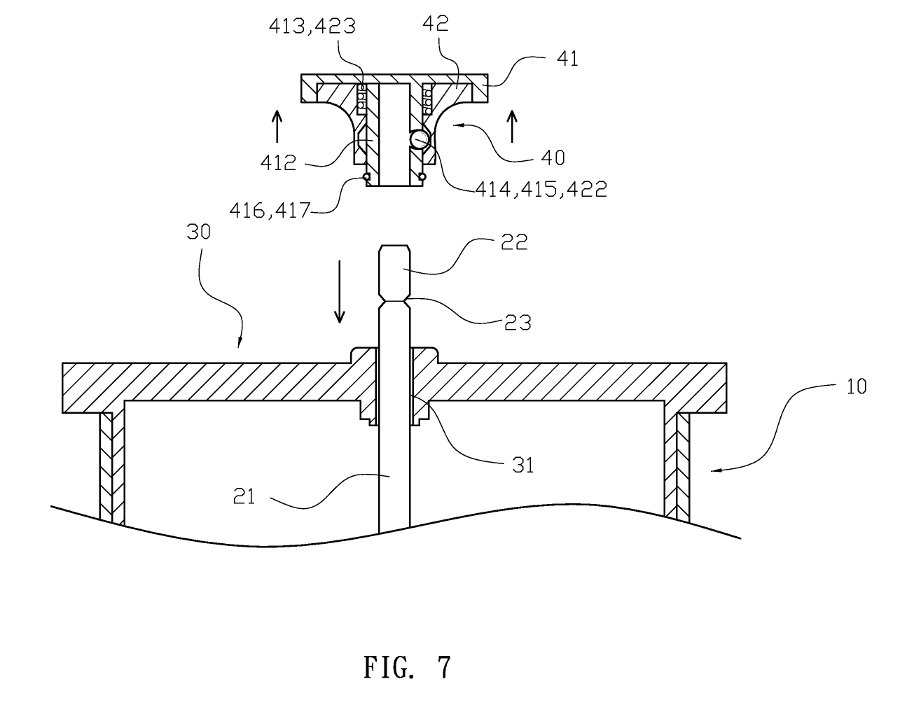

For actual usage, please refer to FIGS. 5 and 6. First, drinking materials may be directly placed in the tea pot 10 or the strainer 20, and different materials may require different methods. Please refer to FIG. 7. In order to change the strainer 20, pushing the housing 42 of the knob 40 towards the main body 41 causes the securing slot 422 in the containment aperture 421 of the housing 42 to move to surround the positioning member 415. Therefore, the positioning member 415 shifts into the securing slot 422 and is thus released from the positioning ring slot 23 around the pull rod 21, thereby permitting the strainer 20 to be released from the knob 40.

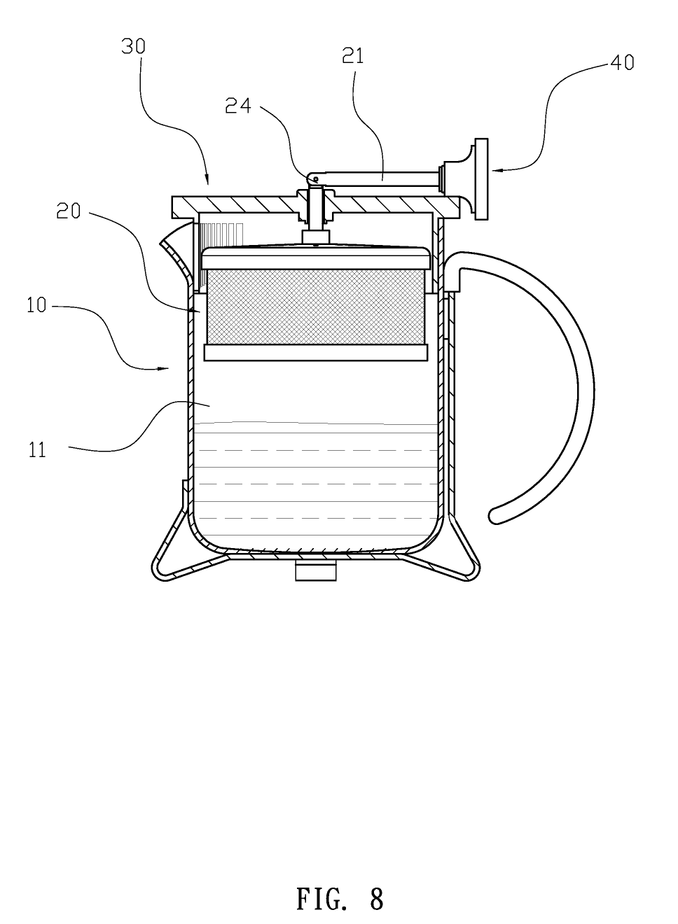

Please refer to FIG. 8. In another embodiment of the present invention, the pull rod 21 of the strainer 20 can comprise two connected rods with a joint 24. When the drink material in the strainer 20 has soaked in water for a while, the user can pull up the pull rod 21 to lift the strainer 20 above the water and bend the pull rod 21 at the joint 24.

With the above-mentioned structure, the following benefits can be obtained: the strainer 20 of the tea pot 10 can be directly exchanged to support different drinking materials.

Although the present invention has been explained in relation to its preferred embodiment, it is to be understood that many other possible modifications and variations can be made without departing from the spirit and scope of the invention as hereinafter claimed.

What is claimed is:

1. A tea pot having a replaceable strainer comprising a strainer, a cover and a knob, characterized in that;
the tea pot shaped as a cup body having a containment space, the strainer having a pull rod extending upward from a center position, an upper end of the pull rod forming an assembly end and a positioning ring slot below the assembly end, the cover designed for covering an upper opening of the tea pot and having a through aperture at a center position, the knob comprising a main body and a housing and the knob further comprising an elastic member and a positioning member, the main body having an extended hollow rod, and the housing jacketed onto the main body;
wherein the pull rod of the strainer passes through the through aperture of the cover, the assembly end is exposed from the cover, the knob is secured onto the assembly end of the pull rod, the assembly end of the pull rod passing through the hollow rod, and the positioning ring slot is engaged with the positioning member of the hollow rod; and wherein when the cover is placed on the tea pot the cover forces the strainer to drop down into the containment space of the tea pot, and the strainer employs the knob to engage with the cover.

2. The tea pot having a replaceable strainer as claimed in claim 1, wherein the strainer is a soak with screened sidewalls or a mixer.

3. The tea pot having a replaceable strainer as claimed in claim 1, wherein the pull rod is a rigid rod body or comprises two connected rods with a joint 24.

4. The tea pot having a replaceable strainer as claimed in claim 1, wherein the main body has an inner space on one side and the hollow rod is disposed in the center position on the same side, the hollow rod jacketed by the elastic member and having a tapered aperture and a positioning member disposed at a middle position on the hollow rod, an engaging slot being disposed around an end of the hollow rod, a fastening member engaged with the slot, the housing engaged with the main body and having a hollow tapered shape with one end corresponding to the inner space of the main body, a containment aperture defined by an inner sidewall, and a securing slot disposed in the inner sidewall around the containment aperture; an enlarged end of the housing further having a limiting opening having a larger diameter than a diameter of the containment aperture such that when the housing is jacketed onto the hollow rod of the main body with the containment aperture, the limiting opening pushes against the elastic member and the securing slot pushes against the positioning member, and a fastening member is secured onto the engaging slot of the hollow rod to secure the housing onto the hollow rod of the main body.
